(19) United States
(12) Patent Application Publication
(10) Pub. No.: US 2007/0070877 A1
(43) Pub. Date: Mar. 29, 2007

(54) Modulation type determination for evaluation of transmitter performance

(76) Inventors: Thomas Sun, San Diego, CA (US); Durk L. Van Veen, Santee, CA (US); Fuyun Ling, San Diego, CA (US); Murali Ramaswamy Chari, San Diego, CA (US)

Correspondence Address: QUALCOMM INCORPORATED, 5775 MOREHOUSE DR., SAN DIEGO, CA, 92121, US

(21) Appl. No.: 11/361,088

(22) Filed: Feb. 22, 2006

Related U.S. Application Data
(60) Provisional application No. 60/734,885, filed on Nov. 8, 2005.
(60) Provisional application No. 60/721,372, filed on Sep. 27, 2005.

(51) Int. Cl. H04J 11/00

(52) U.S. Cl. 370/208

(57) ABSTRACT

Systems and methodologies are described that facilitate monitoring transmitter performance in a wireless communication environment. If the received modulation symbols are unknown during transmitter monitoring, it may be necessary to determine the modulation symbols for each subcarrier. The modulation types can be evaluated over a subset of subcarriers having a consistent modulation type, to reduce the possibility of an erroneous modulation type determination to an extremely low level. A metric can be generated for each modulation type that indicates the likelihood of a particular modulation type for the subset of subcarriers. The modulation type can be selected based upon the metric and modulation symbols consistent with the modulation type can be used for the subset of subcarriers.

### CROSS-REFERENCE TO RELATED APPLICATIONS

This application claims the benefit of U.S. Provisional Application Ser. No. 60/734,885 entitled “HALF INTERLACE BASED SEQUENCE DETECTION ALGORITHM FOR MEDIAFLO TEST RECEIVER,” filed on Nov. 8, 2005. This application is also related to U.S. Provisional Application Ser. No. 60/721,372 entitled “A METHOD FOR MEDIAFLO TRANSMITTER QUALIFICATION,” filed on Sep. 27, 2005. The entireties of the above-referenced applications are incorporated herein by reference.

### BACKGROUND

I. Field

The following description relates generally to wireless communications, and, amongst other things, to evaluating transmitter performance.

II. Background

Wireless networking systems have become a prevalent means by which a majority of people worldwide has come to communicate. Wireless communication devices have become smaller and more powerful in order to meet consumer needs and to improve portability and convenience. Consumers have become dependent upon wireless communication devices such as cellular telephones, personal digital assistants (PDAs) and the like, demanding reliable service and expanded areas of coverage.

A typical wireless communication network (e.g., employing frequency, time, and code division techniques) includes one or more base stations that provide a coverage area and one or more mobile (e.g., wireless) user devices that can transmit and receive data within the coverage area. A typical base station can simultaneously transmit multiple data streams for broadcast, multicast, and/or unicast services, wherein a data stream is a stream of data that can be of independent reception interest to a user device. A user device within the coverage area of that base station can be interested in receiving one, more than one or all the data streams carried by the composite stream. Likewise, a user device can transmit data to the base station or another user device.

Forward Link Only (FLO) technology has been developed by an industry group of wireless communication service providers to utilize the latest advances in system design to achieve the highest-quality performance. FLO technology is intended for a mobile multimedia environment and is suited for use with mobile user devices. FLO technology is designed to achieve high quality reception, both for real-time content streaming and other data services. FLO technology can provide robust mobile performance and high capacity without compromising power consumption. In addition, the technology reduces the network cost of delivering multimedia content by decreasing the number of base station transmitters that are needed to be deployed. Furthermore, FLO technology based multimedia multicasting is complimentary to the wireless operators' cellular network data and voice services, delivering content to the same mobile devices.

Base station transmitter performance is vital to the overall performance of a wireless system. In particular, in a wireless system utilizing FLO technology, which can utilize fewer transmitters, the performance of each transmitter is critical. Therefore, transmitter performance should be carefully monitored before and after installation.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later

In accordance with one or more embodiments and corresponding disclosure thereof, various aspects are described in connection determining the modulation type of a received signal to facilitate monitoring transmitter performance in a wireless communication environment. The modulation types can be evaluated over a subset of subcarriers having a consistent modulation type such as a half-interlace, to reduce the possibility of an erroneous modulation type determination to an extremely low level. A metric can be generated for each modulation type that indicates the likelihood of a particular modulation type for the subset of subcarriers. The modulation type can be selected based upon the metric and modulation symbols consistent with the modulation type can be used for the subset.

According to a related aspect, a method for determining a modulation type of a received signal for a set of subcarriers that have a consistent modulation type can comprise determining the closest modulation symbol to the received signal for each of a plurality of modulation types for each subcarrier in the set of subcarriers, generating a metric for each of the modulation types based upon the difference between the closest modulation symbol and the received signal for each subcarrier in the set of subcarriers and selecting the modulation type of the received signal from the modulation types based upon the metric. The method can further comprise representing the received signal and modulation symbols for the modulation types as points in a complex plane, where the closest modulation symbol is determined based upon the distance in the complex plane between the received signal point and the modulation symbol point. The difference between the closest modulation symbol and the received signal can be measured based upon the distance between the received signal point and the modulation symbol point in the complex plane. Furthermore, generating a metric for each modulation type can comprise summing the distance square between the received signal point and the closest modulation symbol point for the modulation type for each subcarrier in the set of subcarriers. The method can further comprise utilizing the closest modulation symbol for the selected modulation type for each subcarrier to generate a metric indicative of transmitter performance.

According to yet another aspect, an apparatus that determines a modulation type of a received signal for a set of subcarriers that have a consistent modulation type comprises a processor that determines a modulation symbol closest to the received signal for each of a plurality of modulation types for each subcarrier in the set of subcarriers, generates a metric for each of the modulation types based upon the difference between the closest modulation symbol and the received signal for each subcarrier in the set of subcarriers and selects the modulation type of the received signal from the modulation types based upon the metric. The apparatus can further comprise a memory, coupled to the processor, that stores information related to the plurality of modulation types. In a further aspect the processor can represent the received signal and modulation symbols for the plurality of modulation types as points in a complex plane, where the closest modulation symbol is determined based upon the distance in the complex plane between the received signal point and the modulation symbol point. In addition, the processor can sum the distance square between the received signal point and the closest modulation symbol point for the modulation type for each subcarrier in the set of subcarriers to generate the metric.

According to another aspect, an apparatus for determining a modulation type of a received signal for a set of subcarriers that have a consistent modulation type, can comprise means for determining a modulation symbol closest to the received signal for each of a plurality of modulation types for each subcarrier in the set of subcarriers, means for generating a metric for each of the modulation types based upon the difference between the closest modulation symbol and the received signal for each subcarrier in the set of subcarriers and means for selecting the modulation type of the received signal from the modulation types based upon the metric. The apparatus can further comprise means for representing the received signal as a constellation point and means for representing modulation symbols for the modulation types as constellation points, where the closest modulation symbol is determined based upon the distance between the received signal point and the modulation symbol point. In addition, the apparatus can comprise means for summing the distance square between the received signal point and the closest modulation symbol point for the modulation type for each subcarrier in the set of subcarriers.

Yet another aspect relates to a computer-readable medium having stored thereon computer-executable instructions for determining a modulation symbol closest to a received signal for each of a plurality of modulation types for each subcarrier in a set of subcarriers that have a consistent modulation type, generating a metric for each of the modulation types based upon the difference between the closest modulation symbol and the received signal for each subcarrier in the set of subcarriers and selecting the modulation type of the received signal from the modulation types based at least in part upon the metric. The computer-readable medium can also have stored thereon instructions for representing the received signal as a point in a complex plane and representing modulation symbols for the plurality of modulation types as points in the complex plane, the closest modulation symbol is determined based upon the distance in the complex plane between the received signal point and the modulation symbol point. In addition, the computer-readable medium can also have stored thereon instructions for summing the distance square between the received signal point and the closest modulation symbol point for the modulation type for each subcarrier in the set of subcarriers to generate the metric.

Yet another aspect relates to a processor that executes instructions for determining a modulation type of a received signal for a set of subcarriers that have a consistent modulation type, the instructions comprise determining a modulation symbol closest to the received signal for each of a plurality of modulation types for each subcarrier in the set of subcarriers, generating a metric for each of the plurality of modulation types based upon the difference between the closest modulation symbol and the received signal for each subcarrier in the set of subcarriers and selecting the modulation type of the received signal from the plurality of modulation types based upon the metric. The processor can execute instructions for representing the received signal as a point in a complex plane and representing modulation symbols for the plurality of modulation types as points in the complex plane, where the closest modulation symbol is determined based upon the distance in the complex plane between the received signal point and the modulation symbol point. In addition, the processor can execute instructions for summing the distance square between the received signal point and the closest modulation symbol point for the modulation type for each subcarrier in the set of subcarriers.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a transmitter evaluation system according to one or more aspects presented herein.

FIG. 2 is an illustration of a wireless communication system according to one or more aspects presented herein.

FIG. 3 is an illustration of a wireless communication system according to one or more aspects presented herein.

FIG. 4 is an illustration of a transmitter evaluation system according to one or more aspects presented herein.

FIG. 5 is a constellation diagram illustrating the difference between measured signal and transmitted signal.

FIG. 6 illustrates a methodology for evaluating a transmitter in accordance with one or more aspects presented herein.

FIG. 7 illustrates a methodology for evaluating a transmitter in accordance with one or more aspects presented herein.

FIG. 8 illustrates a methodology for generating coarse channel estimates in accordance with one or more aspects presented herein.

FIG. 9 illustrates a methodology for determining modulation symbols in accordance with one or more aspects presented herein.

FIG. 10 illustrates a methodology for determining modulation symbols in accordance with one or more aspects presented herein.

FIG. 11 illustrates the division of a constellation diagram into regions in accordance with one or more aspects presented herein.

FIG. 12 illustrates a methodology for determining modulation symbols during transmitter evaluation in accordance with one or more aspects presented herein.

FIG. 13 illustrates a methodology for evaluating a transmitter using phase correction in accordance with one or more aspects presented herein.

FIG. 14 illustrates a methodology for performing phase correction in accordance with one or more aspect presented herein.

FIG. 15 is an illustration of a system that evaluates transmitter performance in a wireless communication environment in accordance with various aspects presented herein.

FIG. 16 is an illustration of a system that monitors transmitter performance in a wireless communication environment in accordance with various aspects presented herein.

FIG. 17 is an illustration of a wireless communication environment that can be employed in conjunction with the various systems and methods described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. One or more components may reside within a process and/or thread of execution and a component may be localized on one computer and/or distributed between two or more computers. Also, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a user device. A user device can also be called a system, a subscriber unit, subscriber station, mobile station, mobile device, remote station, access point, base station, remote terminal, access terminal, user terminal, terminal, user agent, or user equipment (UE). A user device can be a cellular telephone, a cordless telephone, a Session Initiation Protocol (SIP) phone, a wireless local loop (WLL) station, a PDA, a handheld device having wireless connection capability, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ).

The FLO wireless system has been designed to broadcast real time audio and video signals, as well as non-real time services. The FLO transmission is carried out utilizing tall, high power transmitters to ensure wide coverage in a given geographical area. It is common to deploy multiple transmitters in markets to ensure that the FLO signal reaches a significant portion of the population in a given market.

Typically, FLO technology utilizes orthogonal frequency division multiplexing (OFDM). Frequency division based techniques, such as OFDM, generally separate the frequency spectrum into distinct channels by splitting the frequency spectrum into uniform chunks of bandwidth. For example, the frequency spectrum or band allocated for wireless cellular telephone communication can be split into 30 channels, each of which can carry a voice conversation or, for digital service, digital data. Each channel can be assigned to only one user device or terminal at a time. OFDM effectively partitions the overall system bandwidth into multiple orthogonal frequency channels. An OFDM system may use time and/or frequency division multiplexing to achieve orthogonality among multiple data transmissions for multiple terminals. For example, different terminals may be allocated different channels, and the data transmission for each terminal may be sent on the channel(s) allocated to this terminal. By using disjoint or non-overlapping channels for different terminals, interference among multiple terminals may be avoided or reduced, and improved performance may be achieved.

Base station transmitter performance is vital to the overall performance of a wireless system, particularly a wireless system utilizing FLO technology. Therefore, a system and/or method for testing and evaluating transmitters should be accurate and cost-effective. Transmitters can be tested at the factory or before installation to qualify the transmitters for installation. In addition, transmitters can be tested or monitored after installation to ensure continued transmitter performance. The system and methods described herein can be used to evaluate transmitter performance in wireless environments including, but not limited to, a wireless environment broadcasting FLO, digital multimedia broadcasting (DMB), digital video broadcasting (DVB), DVB-H, DVB-T, DVB-S or DVB-S2 signals.

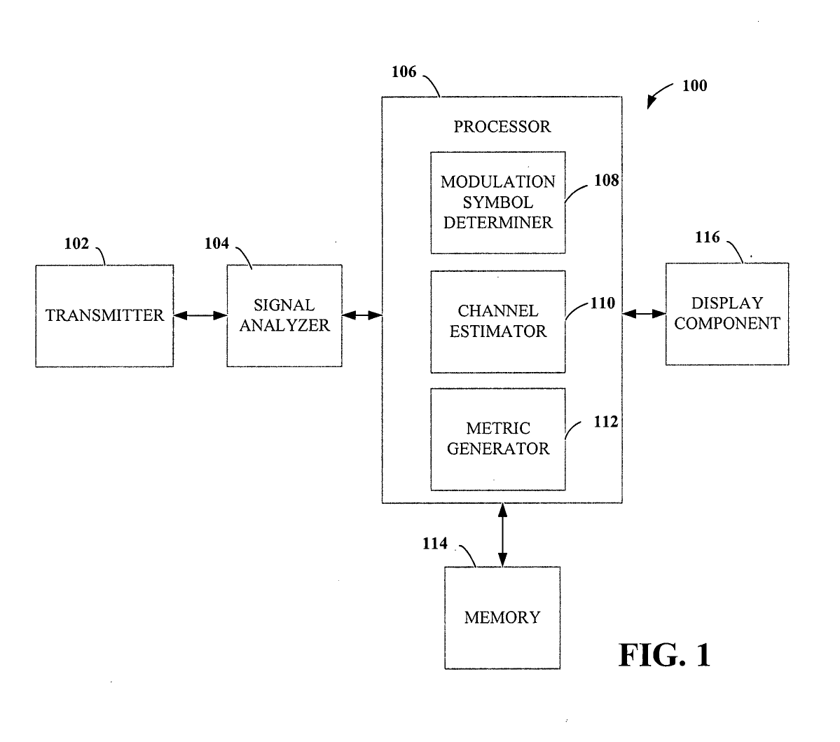

Referring now to FIG. 1, a transmitter evaluation system 100 in accordance with various aspects presented herein is illustrated. System 100 can include a signal analyzer 104 that can be used to sample a signal generated by a transmitter 102. By using signal analyzer 104 rather than a receiver to receive the signal, system 100 can eliminate the receiver as a possible source of additional noise and distortion. System 100 can also include a processor 106 capable of processing the signal captured by signal analyzer 104 and generating metrics to evaluate the performance of transmitter 102. Processor 106 can include a modulation symbol determiner 108. Modulation symbol determiner 108 determines the modulation symbols when the symbols of the received signal are unknown. The received signal is the signal as received or measured by the evaluation system. Processor 106 can include a channel estimator 110 that can be used to generate frequency domain channel estimates for each subcarrier. Processor 106 can also include a metric generator 112 that generates a metric, such as the modulation error rate (MER), to evaluate performance of transmitter 102. The metric produced by metric generator 112 can based upon the frequency domain channel estimates produced by channel estimator 110. System 100 can also include a memory 114 connected to processor 106 that data relating to transmitter performance evaluation (e.g., symbol data and metric data). In addition, system 100 can include a display component 116 to allow a user to monitor transmitter performance through visual feedback generated by the processor.

Processor 106 can provide various types of user interfaces for display component 116. For example, processor 106 can provide a graphical user interface (GUI), a command line interface and the like. For example, a GUI can be rendered that provides a user with a region to view transmitter information. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

In an example, a command line interface can be employed. For example, the command line interface can prompt (e.g., by a text message on a display and an audio tone) the user for information by providing a text message or alert the user that the transmitter performance is outside of predetermined bounds. It is to be appreciated that the command line interface can be employed in connection with a GUI and/or application program interface (API). In addition, the command line interface can be employed in connection with hardware (e.g., video cards) and/or displays (e.g., black and white, and EGA) with limited graphic support, and/or low bandwidth communication channels.

In addition, the evaluation system can generate an alert to notify users if the transmitter performance is outside of an acceptable range. The alert can be audio, visual or any other form intended to attract the attention of a user. The evaluation system can include a predetermined set of values indicating the boundaries of the acceptable range. Alternatively, users may dynamically determine the boundaries. In addition, the evaluation system can generate an alert based upon a change in transmitter performance.

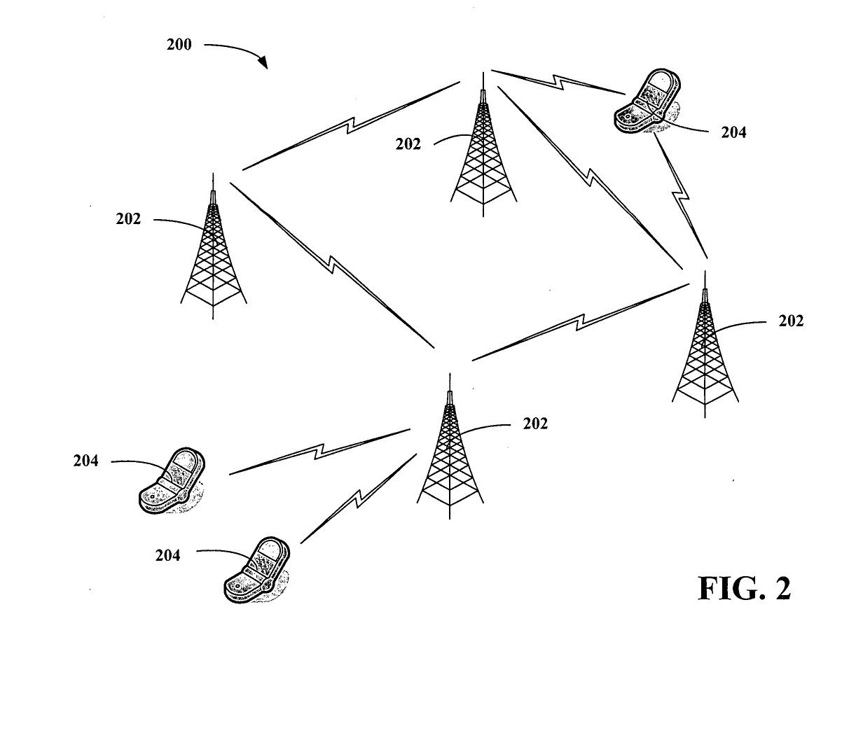

Referring now to FIG. 2, a wireless communication system 200 in accordance with various embodiments presented herein is illustrated. System 200 can comprise one or more base stations 202 in one or more sectors that receive, transmit, repeat, etc., wireless communication signals to each other and/or to one or more mobile devices 204. A base station may be a fixed station used for communicating with the terminals and may also be referred to as an access point, a Node B, or using other terminology. Each base station 202 can comprise a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Mobile devices 204 can be, for example, cellular phones, smart phones, laptops, handheld communication devices, handheld computing devices, satellite radios, global positioning systems, PDAs, and/or any other suitable device for communicating over wireless system 200. In addition, each mobile device 204 can comprise one or more transmitter chains and a receiver chains, such as used for a multiple input multiple output (MIMO) system. Each transmitter and receiver chain can comprise a plurality of components associated with signal transmission and reception (e.g., processors, modulators, multiplexers, demodulators, demultiplexers, antennas, etc.), as will be appreciated by one skilled in the art.

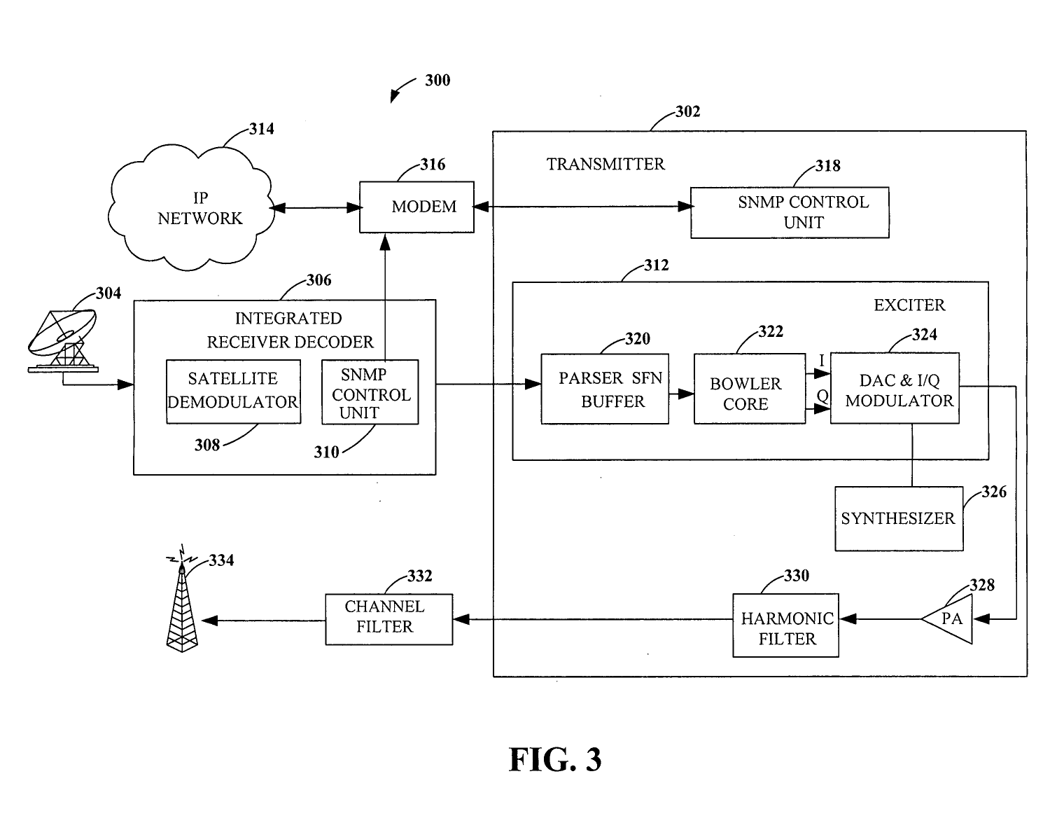

FIG. 3 is an illustration of a wireless communication system 300. System 300 includes a transmitter 302 that can receive data for transmission from a communication satellite system 304. Signals from satellite system 304 can be propagated through an integrated receiver decoder 306 that can include a satellite demodulator 308 and a simple network management protocol (SNMP) control unit 310. Signal data from integrated receiver decoder 306 can be input into an exciter 312 within transmitter 302. In addition, transmitter 302 can be connected to an Internet provider (IP) network 314 through a modem 316. Modem 316 can be connected to a SNMP control unit 318 within transmitter 302. Exciter 312 can include a parser and single frequency network (SFN) buffer 320, a bowler core 322 and a digital to analog converter (DAC) and I/Q modulator 324. Signal data from satellite system 304 can be parsed and stored in parser and SFN buffer 320. Bowler core 322 generates complex number representing the signal data, passing the signal data to DAC and I/Q modulator 324 as in-phase (I) and quadrature (Q) components. DAC and I/Q modulator 324 can utilize a synthesizer 326 to process the signal data and produce an analog, radio frequency (RF) signal. After the data is converted to analog, the resulting RF signal data can be passed to a power amplifier 328 and through a harmonic filter 330. In addition, the data can be passed through a channel filter 332 prior to transmission by antenna 334.

To evaluate transmitter performance, the RF signal data produced by exciter 312 can be monitored. Possible sources of transmitter error or noise include up-sampling, digital to analog conversion and RF conversion. The signal data can be sampled at the output of the exciter and at the output of the channel filter, such that the RF signal can be sampled either before or after power amplification and filtering. If the signal is sampled after amplification, the signal should be corrected for power amplification nonlinearity.

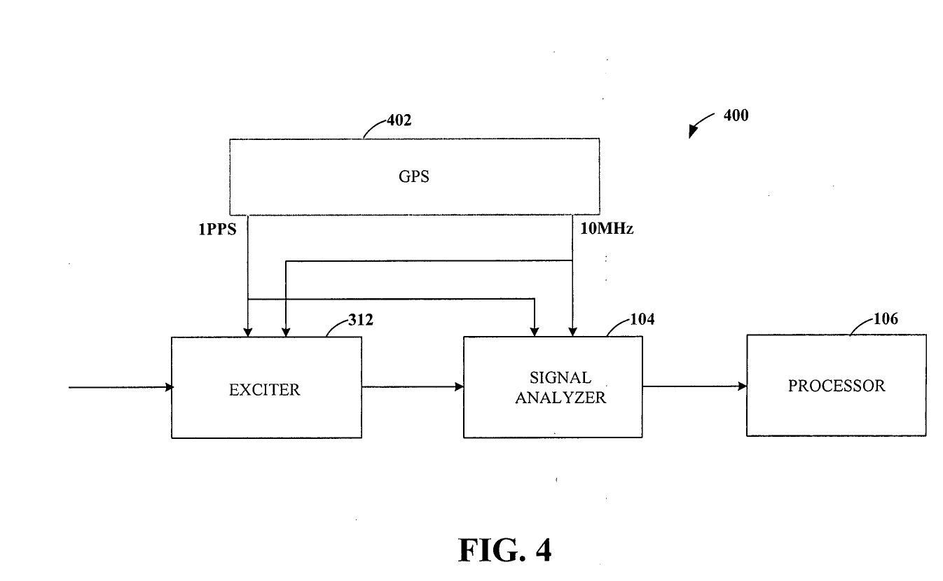

Referring now to FIG. 4, a transmitter evaluation system 400 connected to a transmitter system exciter 312 is illustrated. Signals from a global positioning system (GPS) receiver 402 can be used to synchronize transmitter exciter 312 and signal analyzer 104. An external 10 Megahertz clock from GPS receiver 402 can be fed into both exciter 312 and signal analyzer 104 to act as a common clock reference. To synchronize the start of sampling by signal analyzer 104 to the beginning of the superframe of the RF signal data output by exciter 312, GPS 402 can transmit a 1 pulse per second (PPS) signal to exciter 312 for synchronization and to signal analyzer 104 to trigger the start of sampling. Signal analyzer 104 can generate digital samples of exciter analog output waveform at a rate that is synchronous to the baseband chip rate of the transmitted signal. Sampled data is then fed into processor 106. Processor 106 can be implemented using a general-purpose processor or a processor dedicated to analyzing transmitter data. Use of a general-purpose processor can reduce the cost of transmitter evaluation system 400. Signal analyzer 104 can be configured to run in floating point mode to avoid quantization noise.

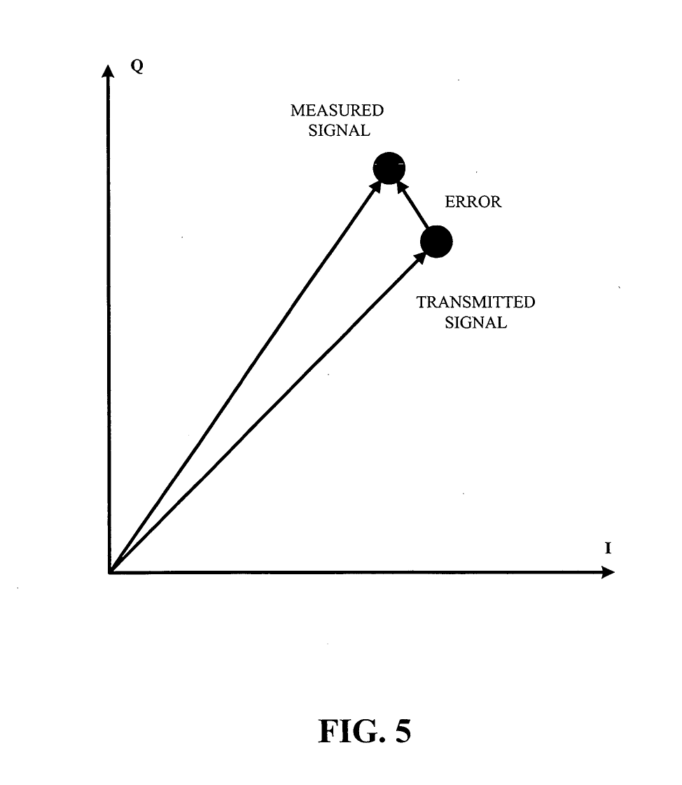

Referring now to FIG. 5, a constellation diagram illustrating the difference between received or measured signal and transmitted signal is shown. The axes of the constellation diagram represent the real and imaginary components of complex numbers, referred to as the in phase or I-axis and the quadrature or Q-axis. The vector between the received or measured signal constellation point and the transmitted signal constellation point represents the error, which can include digital to analog conversion inaccuracies, power amplifier nonlinearities, in-band amplitude ripple, transmitter IFFT quantization error and the like.

The transmitter evaluation system can generate one or more metrics to evaluate the performance of the transmitter. Metrics generated by processor include, but are not limited to, modulation error ratio (MER), group delay or channel frequency response. In particular, MER measures the cumulative impact of flaws within the transmitter. MER for a subcarrier is equivalent to signal to noise ratio (SNR) for a subcarrier. MER can be generated using the following equation:

$$MER ( dB ) = 10 log \frac{\frac{1}{N} {\sum }_{1}^{N} ( {I}^{2} + {Q}^{2} )}{\frac{1}{N} {\sum }_{1}^{N} ( Δ {I}^{2} + Δ {Q}^{2} )}$$

Here, I is the in phase value of the measured constellation point, Q is the quadrature value of the measured constellation point and N is the number of subcarriers. ΔI is the difference between the in phase values of the transmitted and measured signals and ΔQ is the difference between the quadrature values of the transmitted and measured signals.

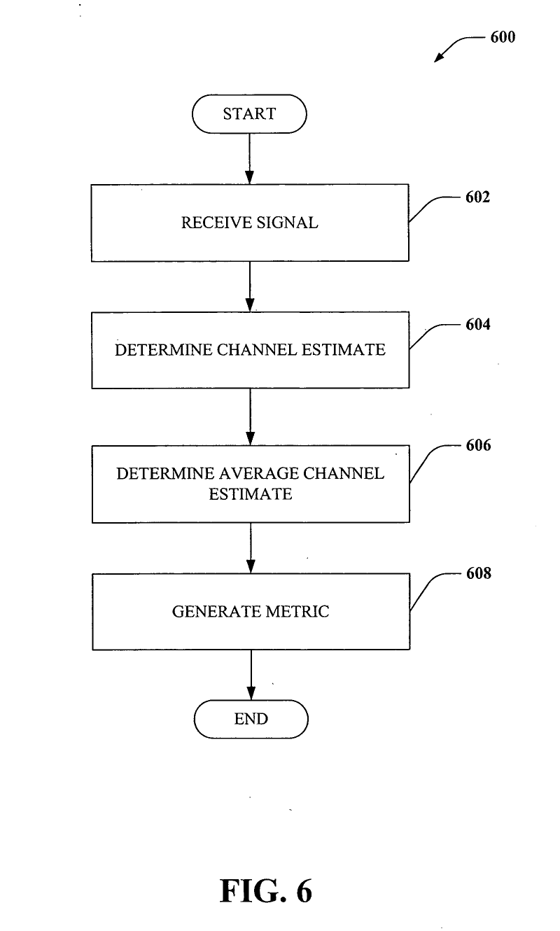

Referring to FIGS. 6-10 and 12-13, methodologies relating to evaluating transmitter performance in wireless communication systems are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be utilized to implement a methodology in accordance with one or more embodiments.

Referring now to FIG. 6, a methodology 600 for processing RF signal data received from a transmitter and evaluating transmitter performance is illustrated. Typically, transmitters broadcast real time scheduled data streams in superframes. A superframe can include a group of frames (e.g., 16 frames) where a frame is a logical unit of data.

At 602, the signal is received or sampled from the transmitter. The received signal can be written as follows:
Yₖ=Hₖ·Pₖ+Nₖ
Here, Hₖ, is the channel of a subcarrier, k. A known modulation symbol, Pₖ, can be transmitted on the subcarrier k. Complex additive white Gaussian noise (AWGN) with a zero mean and a variance of σ² can be represented by Nₖ.

The possible modulation types for the subcarriers can include, but are not limited to, quadrature phase-shift keying (QPSK), layered QPSK with an energy ratio of 6.25 (ER6.25), 16 QAM (quadrature amplitude modulation) and layered QPSK with energy ratio of 4.0 (ER4). When analyzed based upon the constellation point of view, the layered QPSK with energy ratio 4.0 is identical to that of 16 QAM. Constellation point of view, as used herein, refers to utilization of constellation diagrams to represent digital modulation schemes in the complex plane. Modulation symbols can be represented as constellation points on a constellation diagram.

An initial frequency domain channel estimate for a subcarrier can be determined at 604. An initial channel estimate for each subcarrier can be obtained by dividing the signal Yₖ by a known symbol, Pₖ. Selected symbols can be transmitted, such that the symbols are known for the purpose of performance evaluation. For example, during testing prior to installation, a particular pattern of symbols can be transmitted such that the symbol for each subcarrier is predictable and therefore known. Determination of modulation symbols when the transmitted modulation symbols are unknown is discussed in detail below. The initial frequency domain channel estimate for each subcarrier, k, of every OFDM symbol, l, within a superframe, can be represented as follows:

$${Z}_{k , l} = {Y}_{k , l} / {P}_{k , l} = {H}_{k , l} + \frac{{N}_{k , l} \cdot {P}_{k , l}^{*}}{{\vert {P}_{k , l} \vert}^{2}}$$

Here, Z_{k,l} is an initial channel estimate for subcarrier k and OFDM symbol l.

An average channel estimate is determined at 606. The channel estimate Z_{k,l} of subcarrier can be refined by averaging over the entire superframe, such that:

$${\hat{H}}_{k} = {H}_{k} + \frac{1}{L} {\sum }_{1 = 0}^{L - 1} \frac{{N}_{k , 1} \cdot {P}_{k , 1}^{*}}{{\vert {P}_{k , 1} \vert}^{2}}$$

Here, k is the OFDM symbol index and L is the number of the OFDM symbols in the superframe (e.g., 1188 symbols). Since the variance of the average channel estimate is smaller than the variance of the initial channel estimate, the variance of the average channel estimate can be used to approximate the channel gain of the subcarrier during metric generation.

At 608, a metric for evaluating the transmitter performance is generated. For example, the MER for a subcarrier k can be generated. Assuming that the transmitted symbols are known, noise variance can be estimated by the following:

$${W}_{k , m} = {Y}_{k , m} - {\hat{H}}_{k} \cdot {X}_{k , m} = {N}_{k , m} - \frac{1}{L} {\sum }_{l = 0}^{L - 1} \frac{{N}_{k , l} \cdot {X}_{k , l}^{*}}{{\vert {X}_{k , l} \vert}^{2}} \cdot {X}_{k , m}$$

Here, the X_{k,m} represents the transmitted symbol for subcarrier k. It can be shown that the in-phase and quadrature components of the noise, Wₖ, is approximately:

$$N ( 0 , ( 1 - \frac{1}{L} ) \frac{{σ}^{2}}{2} )$$

if random variable Bₖ is the estimated noise variance, such that:

$${B}_{k} = \frac{1}{L - 1} {\sum }_{l = 1}^{L} {W}_{k , l}^{2}$$

$$and \text{:}$$

$$E ( {B}_{k} ) = \frac{L}{L - 1} E ( {W}_{k}^{2} ) = {σ}^{2}$$

The MER can be determined based upon the average channel estimate for the subcarrier, the symbol transmitted on the subcarrier and the signal received for the subcarrier. A MER can be calculated based upon the following exemplary equation:

$${MER}_{k} = \frac{E {\vert {H}_{k} \cdot {P}_{k} \vert}^{2}}{E {\vert {Y}_{k} - {H}_{k} \cdot {P}_{k} \vert}^{2}} = \frac{E {\vert {H}_{k} \vert}^{2} \cdot E {\vert {P}_{k} \vert}^{2}}{E {\vert {N}_{k} \vert}^{2}} \approx \frac{E {\vert {\hat{H}}_{k} \vert}^{2} \cdot E {\vert {P}_{k} \vert}^{2}}{E ( {B}_{k} )}$$

Here, Ĥₖ is the average channel estimate for subcarrier k, Pₖ is the symbol transmitted on the subcarrier, Yₖ is the received signal and Nₖ is the AWGN. In addition, MER can be calculated by averaging over all of the subcarriers.

Additional metrics can be generated to evaluate transmitter performance. For example metrics can include frequency response and group delay. Group delay of subcarrier k can be calculated as follows:

$${GD}_{k} = - \frac{ⅆ θ}{ⅆ ω} {\vert}_{k} = - \frac{1}{2 π} E ( \frac{{Δφ}_{k , k - 1}}{Δ {f}_{k , k - 1}} )$$

Here, k=1, . . . , 4000; Δφ_{k,k-1} is the phase difference between subcarriers k and k−1; and Δf_{k,k-1} is the frequency difference between subcarriers k and k−1.

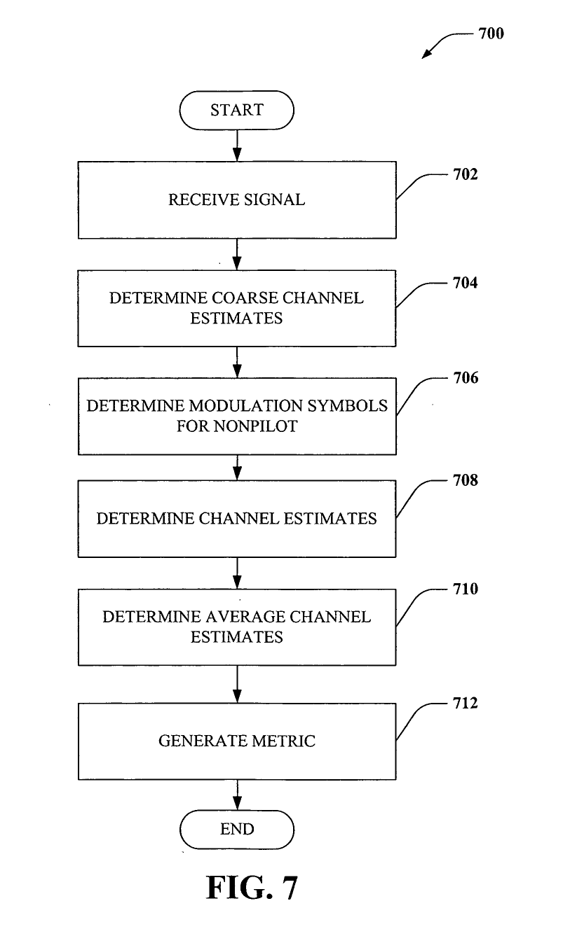

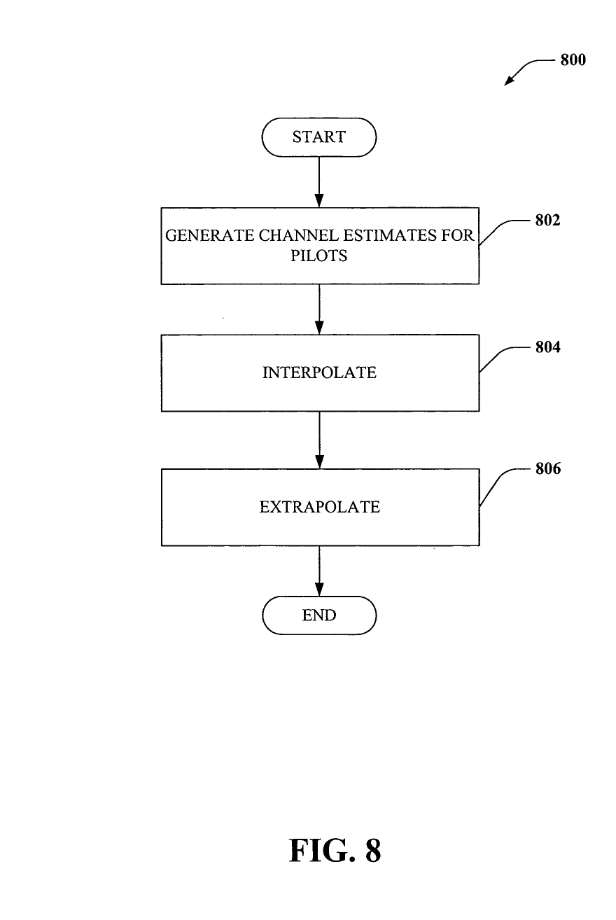

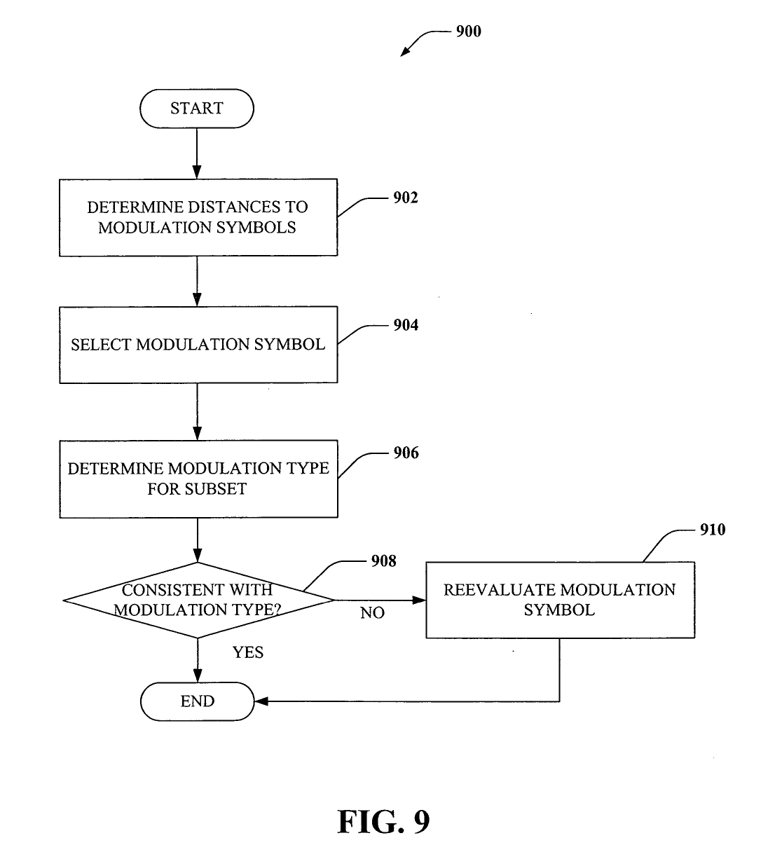

Referring now to FIG. 7, a methodology 700 for evaluating a transmitter where the transmitted symbols are unknown is illustrated. The modulation symbols (e.g., QPSK or 16 QAM symbols) are unknown when real time data streams are transmitted. However, the pilot symbols are known. At 702, a signal is received. A coarse initial channel estimate for the subcarriers can be generated at 704. The coarse initial channel estimation can be performed using the known pilot symbols and linear interpolation and extrapolation, as described with respect to FIG. 8 below. At 706, the modulation symbols for the subcarriers are determined. The modulation symbols can be determined using a constellation diagram as described below with respect to FIGS. 9 through 12. The modulation symbols can be selected based upon the distance between the received signal constellation point and the closest modulation symbol constellation point. Symbol selection is described in further detail below. At 708, an initial frequency domain channel estimate for each subcarrier can be determined. An initial channel estimate for each subcarrier can be obtained by dividing the received signal by the modulation symbol.

At 710, the channel estimates are averaged over the superframe to increase accuracy. The average channel estimate can be determined using the coarse channel estimates, the channel estimates based upon the modulation symbols or both sets of channel estimates. A metric for evaluating the transmitter based at least in part upon the channel estimates can be generated at 712. For example, the MER for each subcarrier can be determined based upon the channel estimates and the modulation symbol, as described in detail above.

Referring now to FIG. 8, a methodology 800 for generating coarse channel estimates is illustrated. As discussed in detail above, the received signal can be written as a function of the channel estimate, the symbol for the subcarrier and a noise term, AWGN. In each OFDM symbol, there are a predetermined number of subcarriers carrying pilot symbols known to the receiver, (e.g., 500 subcarriers carrying pilot QPSK symbols). Therefore, the modulation symbols are known for this subset of subcarriers. Consequently, at 802 the channel estimate can be calculated for the pilot subcarriers. At 804, the channel estimates for subcarriers between two pilot subcarriers can be obtained using linear interpolation. At 806, the channel estimates for subcarriers at the ends of the super frame, and consequently not located between pilot subcarriers, can be obtained using linear extrapolation.

In addition, since there is (2, 6) pattern staggering of pilot symbols for the OFDM symbols of a super frame, both the 500 pilots of the current OFDM symbol and the 500 pilots of the previous OFDM symbol can be used to obtain the frequency domain channel estimation. In such cases, the channel estimates of the pilot subcarriers are generated using the pilot symbols and the channel estimates of the rest of the subcarriers are obtained by linear interpolation or extrapolation.

Referring now to FIG. 9, a methodology 900 for determining modulation symbols is illustrated. At 902, the distances between the constellation point of the received signal and the constellation points of possible modulation symbols are calculated. For example, the distance between the received signal constellation point and the QPSK constellation point closest the signal constellation point, as well as the distance between the signal constellation point and the 16 QAM constellation point closest to the signal constellation point can be calculated. At 904, the modulation symbol constellation point closest to the signal constellation point is selected as the modulation symbol. To increase accuracy in selection of modulation symbols, the modulation symbol can be compared to the modulation type for a subset of the subcarriers having a consistent modulation type. A half-interlace is used herein as an example of a subset of subcarriers that has a consistent modulation type. However, in the systems and methods discussed herein, the subset of subcarriers having a consistent modulation type is not limited to a half-interlace. Errors in modulation symbol selection can be avoided by checking the modulation symbol for a subcarrier against the modulation type for the subset of subcarriers. The modulation type for the subset of subcarriers can be determined at 906. At 908, it is determined whether the modulation symbol is consistent with the modulation type. If yes, the process terminates. If no, the modulation symbol is reevaluated and a modulation symbol consistent with the modulation type is selected at 910.

Typically, the modulation type remains consistent during a half interlace. In general the modulation type does not change within an interlace due to constraints in the FLO protocol. An interlace, as used herein is a set of subcarriers (e.g., 500 subcarriers). Consequently, a half-interlace is one half of an interlace (e.g., 250 subcarriers). However, for rate-⅔ layered modulation, the modulation type can be switched to QPSK within an interlace when operating in base-layer only mode. Even under these conditions the modulation type within each half-interlace remains constant. Therefore, the modulation type for each half-interlace can be determined using majority voting. To determine the modulation type for a half-interlace or any other subset of subcarriers having a consistent modulation type, the modulation symbol, and consequently the modulation type, can be determined for each subcarrier within the subset. A majority vote based on the modulation type corresponding to each subcarrier can be used to determine the modulation type for the subset. For example, for a half-interlace including 250 subcarriers, the modulation type for 198 of the subcarriers could be consistent with the QPSK modulation type and the modulation symbols for the remaining 52 subcarriers could be consistent with the 16 QAM modulation type. Since the majority of the subcarriers are detected as QPSK, QPSK would be selected as the modulation type for the half-interlace. The 52 subcarriers that were associated with the 16 QAM modulation type can be reevaluated and reassigned to QPSK modulation symbols based upon their location in the constellation diagram. Comparing the subcarrier modulation symbol to the modulation type for the half-interlace and reevaluating subcarrier modulation symbols as needed increases the accuracy of modulation symbol selection.

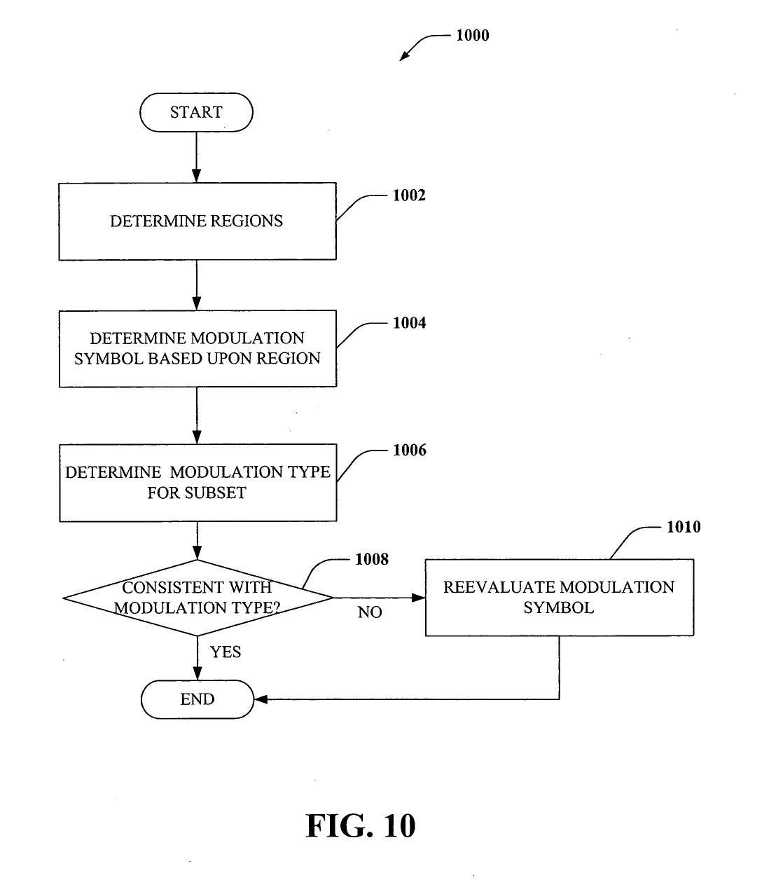

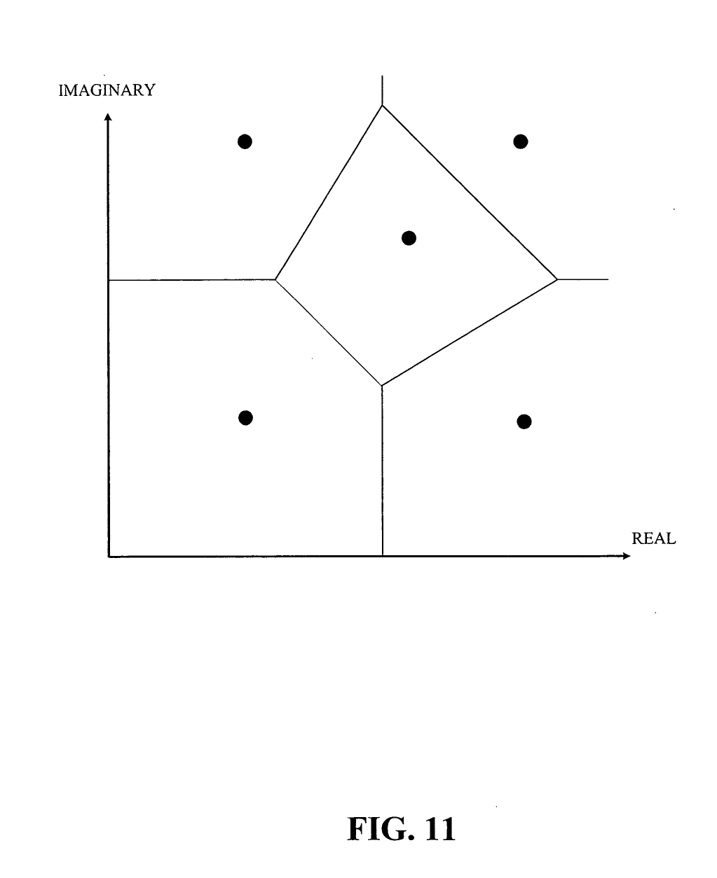

Referring now to FIGS. 10-11, a methodology 1000 for determining modulation symbols is illustrated in FIG. 10. At 1002, a constellation diagram including constellation points representing various modulation symbols is divided into a series of regions. Each region is associated with a modulation symbol constellation point. Regions are defined such that every point in each region has the property that the distance of such a point to the constellation point of the region is less than or equal to the distance between such point to the constellation point of any other region. A set of regions covering the first quadrant of the constellation diagram is illustrated in FIG. 11. At 1004, the region in which the received signal constellation point is located is determined. The modulation symbol corresponding to the region in which the received signal constellation point is located is selected as the modulation symbol. The modulation symbol can be checked against the modulation type for a subset of subcarriers having a consistent modulation type (e.g., a half-interlace). The modulation type for the subset of subcarriers can be determined at 1006. At 1008, it is determined whether the modulation symbol is consistent with the modulation type. If yes, the process terminates. If no, the modulation symbol is reevaluated and a modulation symbol consistent with the modulation type is selected at 1010. If the modulation symbol is inconsistent with the modulation type of the subset, the modulation symbol consistent with the modulation type is selected.

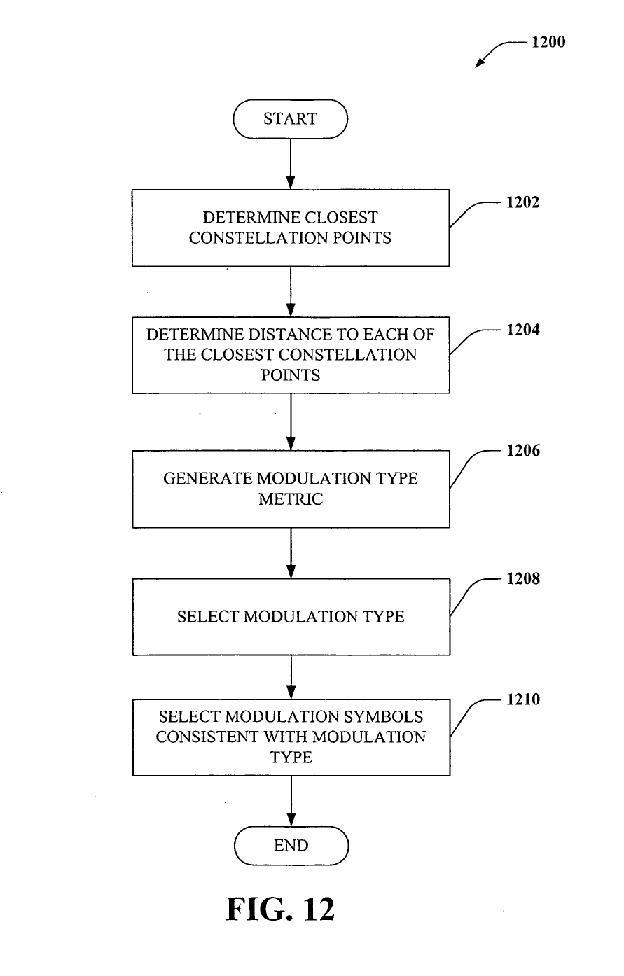

Referring now to FIG. 12, a methodology 1200 for determining the modulation type and modulation symbols for a subset of subcarriers having a consistent modulation type (e.g., a half-interlace) is illustrated. At 1202, the modulation symbol constellation point closest to the signal constellation point is determined for each modulation type. The closest modulation symbol constellation point for each modulation type is determined for each subcarrier. For example, if there are three possible modulation types (e.g., 16 QAM, ER4 and ER6.25), three closest modulation symbol constellation points, one for each type, are determined for every subcarrier in the subset of subcarriers.

The closest modulation symbol constellation point for a modulation type can be determined by calculating the distance between the received signal constellation point and possible modulation symbol constellation points and selecting the modulation symbol constellation point corresponding to the minimum distance. Alternatively, the closest modulation symbol constellation points can be determined using regions. The closest modulation symbol constellation point for a particular modulation type can be determined by partitioning the constellation diagram into regions corresponding to the modulation symbols of the modulation type. Regions are defined such that every point in each region has the property that the distance of such a point to the constellation point of the region is less than or equal to the distance between such point to the constellation point of any other region. The modulation symbol corresponding to the region in which the received signal constellation point is located is selected as the closest modulation symbol constellation point for that particular modulation type.

At 1204, if the distance was not calculated above, the distance between the signal constellation point and each of the closest modulation symbol points is determined for each subcarrier in the subset of subcarriers. Whether the distance was calculated previously or at 1204, a distance value for each modulation type will be associated with each subcarrier. For example, if there are three possible modulation types, each subcarrier in the subset will have three distance values associated with it. Each of the distance values corresponds to one of the three possible modulation types. The distance value can be calculated as the minimum distance square between the closest modulation symbol constellation point for a modulation type and the signal constellation point.

At 1206, a metric is generated for each modulation type over the subset. The metric for a modulation type can be generated by summing the distance square values for each subcarrier in the subset for that modulation type. Alternatively, the metric for a modulation type can be generated by averaging the distance values for each subcarrier in the subset for that modulation type. At 1208, the modulation type can be selected based upon the generated metrics. For example, if the metric is generated by summing the distance square values for each subcarrier in the subset for a modulation type, the selected modulation type should correspond to the metric with the smallest value. Once the modulation type for the subset has been selected, modulation symbols corresponding to the closest modulation symbol points for the selected modulation type can be used as the modulation symbol for the subcarrier at 1210.

The transmitter evaluation systems and methods described herein should also include phase correction, intended to reduce or eliminate error or distortions caused by time frequency offsets. If phase correction is not performed, the channel estimate average can be inaccurate and consequently, the evaluation metrics may be incorrect. Typically, phase correction can be performed prior to the averaging of the channel estimates to correct for phase ramp due to frequency offsets.

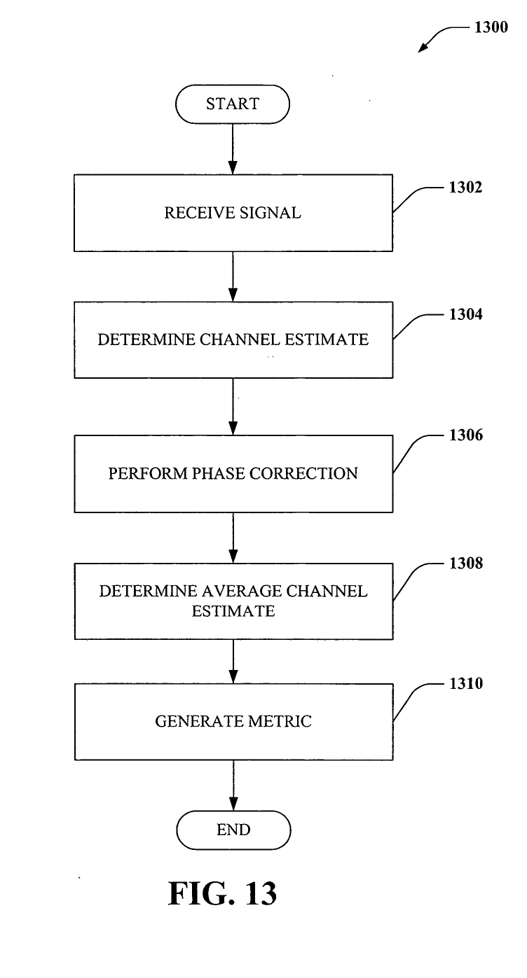

Referring now to FIG. 13, a methodology 1300 for evaluating a transmitter using phase correction is illustrated. At 1302, the signal is received from the transmitter. Channel estimates for subcarriers can be determined at 1304. The channel estimates can be determined using known symbols, as illustrated in FIG. 6, or unknown symbols, as illustrated in FIG. 7. At 1306, phase correction can be performed. After phase correction, the average channel estimate can be determined at 1308. A metric for evaluating transmitter performance can be generated at 1310. For example, the MER for the subcarrier can be determined based upon the channel estimate.

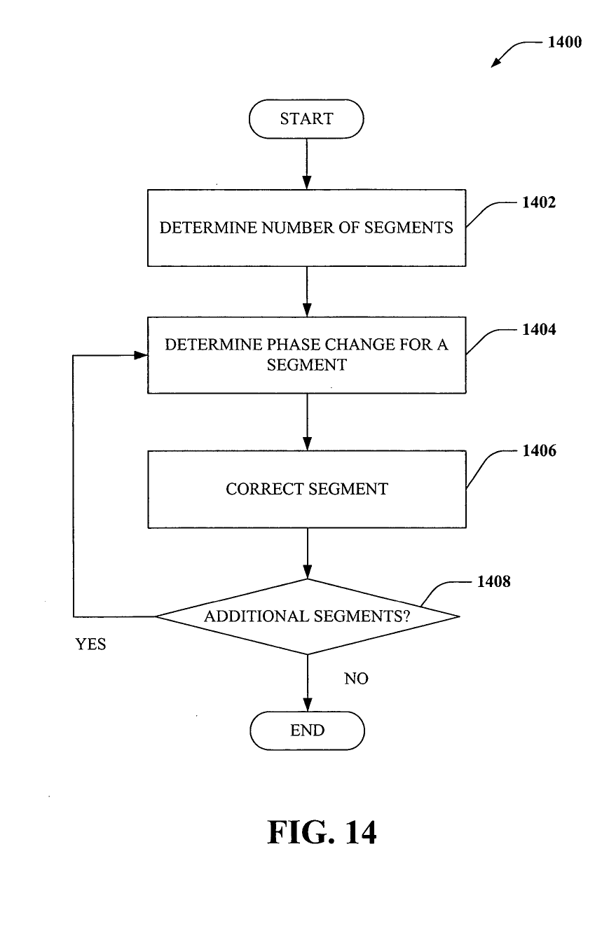

Referring now to FIG. 14, a methodology 1400 for correcting frequency offset is illustrated. The received signal including a frequency offset can be written as follows:

$$r ( t ) = {\sum }_{n = 0}^{N - 1} {R}_{n} {ⅇ}^{j ( {ω}_{0} + n {ω}_{s} + Δ ω ) t}$$

Here Rₙ is the complex amplitude of the nth subcarrier and N is the total number of subcarriers. The frequency of the initial subcarrier is represented by ω₀, ωₛ represents the subcarrier spacing and Δω is the frequency offset. A constant frequency offset will result in a linear phase change with time. A frequency offset that varies linearly with time will result in a parabolic phase change over time. Either a constant or linearly changing frequency offset results in a predictable phase change which can be corrected prior to averaging, as shown in FIG. 13.

A linear phase change can be corrected using a first order phase correction algorithm by calculating the slope of phase change. For example, the phase change can be calculated as follows:

$$\frac{ⅆ φ}{ⅆ t} = \frac{1}{{T}_{OFDM}} {\sum }_{l = 0}^{L} Δ {φ}_{l + 1} = \frac{{φ}_{L} - {φ}_{0}}{L}$$

Here, Δφₖ₊₁=φₖ₊₁−φₖ is the phase change of the channel estimation between two adjacent OFDM symbols, φ₀ is the phase of the initial channel estimation, L is the number of OFDM symbols and T_{OFDM} is period.

A parabolic phase change can be corrected using a second order phase correction with a LS algorithm to determine the parameters, a, b and c, of the parabolic function. The estimated phase can be written as follows:
φₑₛₜ=a·t²b·t+c
Here, t is time. The estimated phase can be used to correct the estimated channels prior to averaging.

However, the frequency offset is not necessarily constant or linearly varying. Consequently, the phase change is not necessarily linear or parabolic and predictable. One possible solution for correcting for a variable frequency offset includes separating the time duration into segments and then estimating the phase change for each segment. As a result, the estimated noise variance Bₖ in the MERₖ equation described with respect to FIG. 6 should be modified as follows:

$${B}_{k} = \frac{2}{2 L - N - 1} {\sum }_{l = 1}^{L} {W}_{k , l}^{2}$$

Here, N is the number of segments.

The noise term for each channel of each OFDM symbol derived from the received signal can be decomposed into two orthogonal dimensions: amplitude dimension and phase dimension. The noise term in the amplitude dimension can be considered additive white Gaussian noise. The noise term in the phase direction can be considered the sum of the additive white Gaussian noise (AWGN) and the distortion that comes from the frequency offset. The distortion caused by the frequency offset should be eliminated. However, the component of AWGN in the phase dimension should be maintained.

As shown in the methodology 1400 illustrated in FIG. 14, at 1402 the number of segments into which the time will be divided is determined. At 1404 the phase change due to frequency offset is estimated for a segment. The segment is corrected using either a first or second order correction algorithm at 1406. At 1408 a determination is made as to whether there are additional segments to correct. If yes, the process returns to 1404 to determine the phase correction for the next segment. If no, the process terminates.

In one extreme case, if the variance of the noise in the amplitude dimension is equal to that of the variance of the noise in the phase dimension, the maximum number of segments is equal to the number of OFDM symbols being processed. Consequently, the noise in the phase dimension will be eliminated as well as the distortion due to frequency offset. As a result, the true value of MER, which includes the noise in the phase dimension, will be equal to the value of the generated MER minus a constant (e.g., 3.01 dB).

It will be appreciated that, in accordance with one or more embodiments described herein, inferences can be made regarding transmission formats, frequencies, etc. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences regarding the number of segments to utilize for phase correction. In addition, inferences can be made regarding the data and format to display to a user.

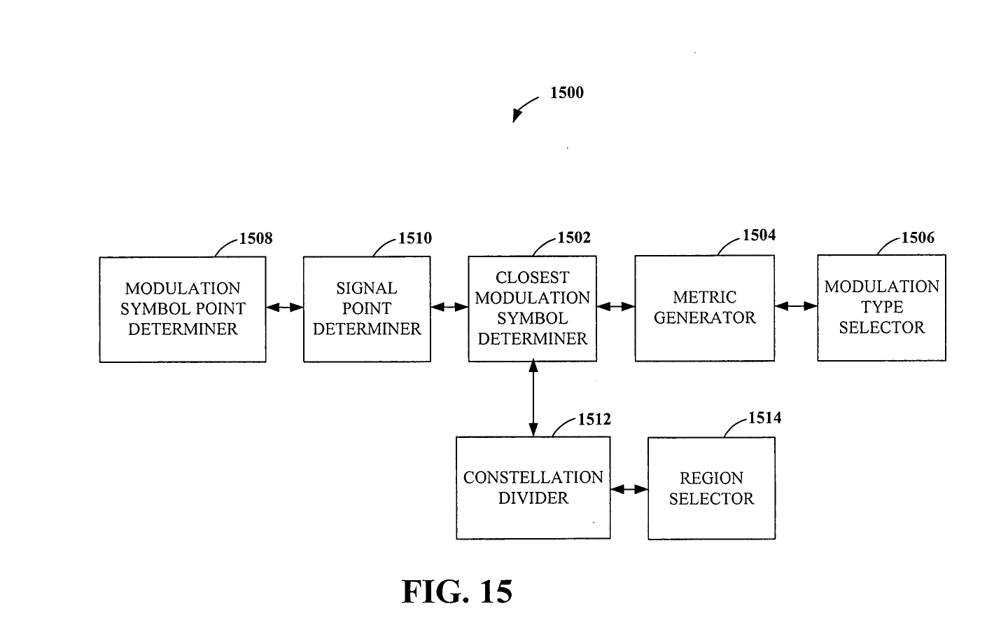

Referring now to FIG. 15, a system 1500 for determining the modulation type for a subset of subcarriers having a consistent modulation type (e.g., a half-interlace) to facilitate evaluating transmitter performance in a wireless communication environment in accordance with one or more aspects presented herein is illustrated. System 1500 can include a closest modulation symbol determiner 1502, a metric generator 1504 and a modulation type selector 1506. Closest modulation symbol determiner 1502 determines a modulation symbol closest to the received signal for each modulation type for each subcarrier in the subset. Metric generator 1504 can generate a metric for each modulation type based on the difference between the closest modulation symbol for that modulation type and the received signal for each subcarrier in the subset. Modulation type selector 1506 can select the modulation type of the received signal based upon the metric generated by metric generator 1504. In addition, system 1500 can include a modulation symbol point determiner 1508 that can represent the modulation symbols as constellation points on a constellation diagram. A signal point determiner 1510 can represent the received signal as a constellation point. The closest modulation symbol can be determined based upon the distance between the received signal point and the modulation symbol points. System 1500 can also include constellation divider 1512 that can divide the constellation diagram into a set of regions for each modulation type and region selector 1514 that can determine the region in which the received signal point is located for each of the sets of regions for each subcarrier. The closest modulation symbol for a modulation type corresponds to the region in which the received signal point is located.

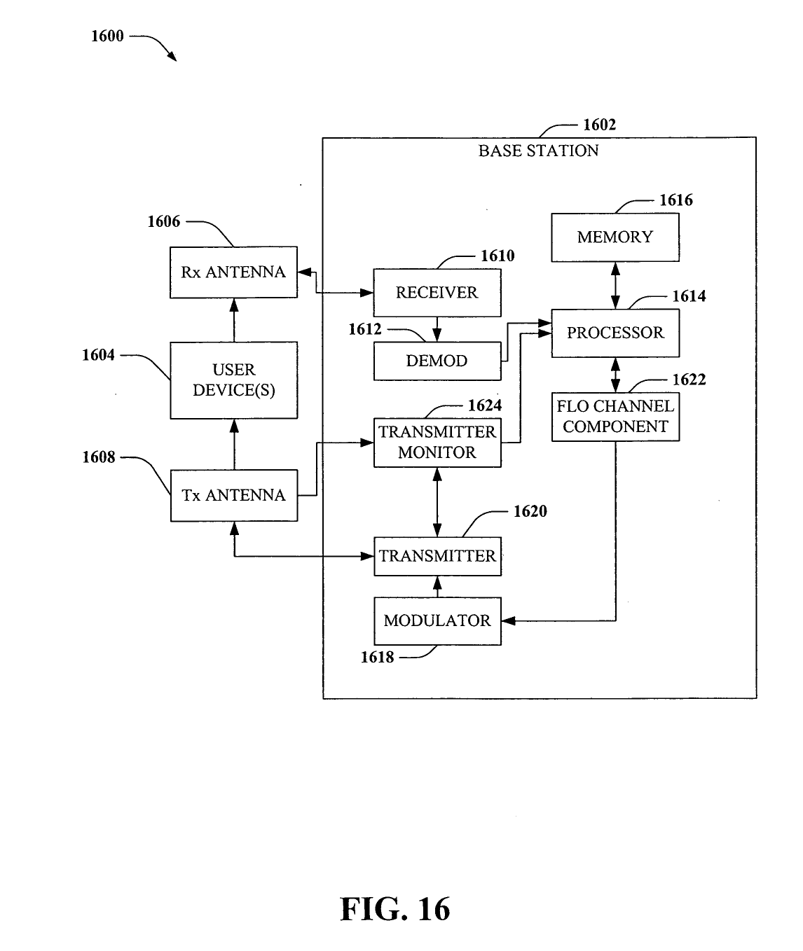

FIG. 16 is an illustration of a system 1600 that provides for monitoring transmitter performance in a communication environment. System 1600 comprises a base station 1602 with a receiver 1610 that receives signal(s) from one or more user devices 1604 via one or more receive antennas 1606, and transmits to the one or more user devices 1604 through one or more transmit antennas 1608. In one or more embodiments, receive antennas 1606 and transmit antennas 1608 can be implemented using a single set of antennas. Receiver 1610 can receive information from receive antennas 1606 and is operatively associated with a demodulator 1612 that demodulates received information. Receiver 1610 can be, for example, a Rake receiver (e.g., a technique that individually processes multi-path signal components using a plurality of baseband correlators, . . . ), an MMSE-based receiver, or some other suitable receiver for separating out user devices assigned thereto, as will be appreciated by one skilled in the art. According to various aspects, multiple receivers can be employed (e.g., one per receive antenna), and such receivers can communicate with each other to provide improved estimates of user data. Demodulated symbols are analyzed by a processor 1614. Processor 1614 can be a processor dedicated to analyzing information received by receiver component 1614 and/or generating information for transmission by a transmitter 1614. Processor 1614 can be a processor that controls one or more components of base station 1602, and/or a processor that analyzes information received by receiver 1610, generates information for transmission by a transmitter 1620, and controls one or more components of base station 1602. Receiver output for each antenna can be jointly processed by receiver 1610 and/or processor 1614. A modulator 1618 can multiplex the signal for transmission by a transmitter 1620 through transmit antennas 1608 to user devices 1604. Processor 1614 can be coupled to a FLO channel component 1622 that can facilitate processing FLO information associated with one or more respective user devices 1604.

Base station 1602 can also include a transmitter monitor 1624. Transmitter monitor 1624 can sample transmitter output and/or transmitter antenna output and evaluate the performance of transmitter 1620. Transmitter monitor 1624 can be coupled to processor 1614. Alternatively, transmitter monitor 1624 can include a separate processor for processing transmitter output. In addition, transmitter monitor 1624 may be independent of base station 1602.

Base station 1602 can additionally comprise memory 1616 that is operatively coupled to processor 1614 and that can store information related to constellation regions, modulation symbols and/or any other suitable information related to performing the various actions and functions set forth herein. It will be appreciated that the data store (e.g., memories) components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1616 of the subject systems and methods is intended to comprise, without being limited to, these and any other suitable types of memory.

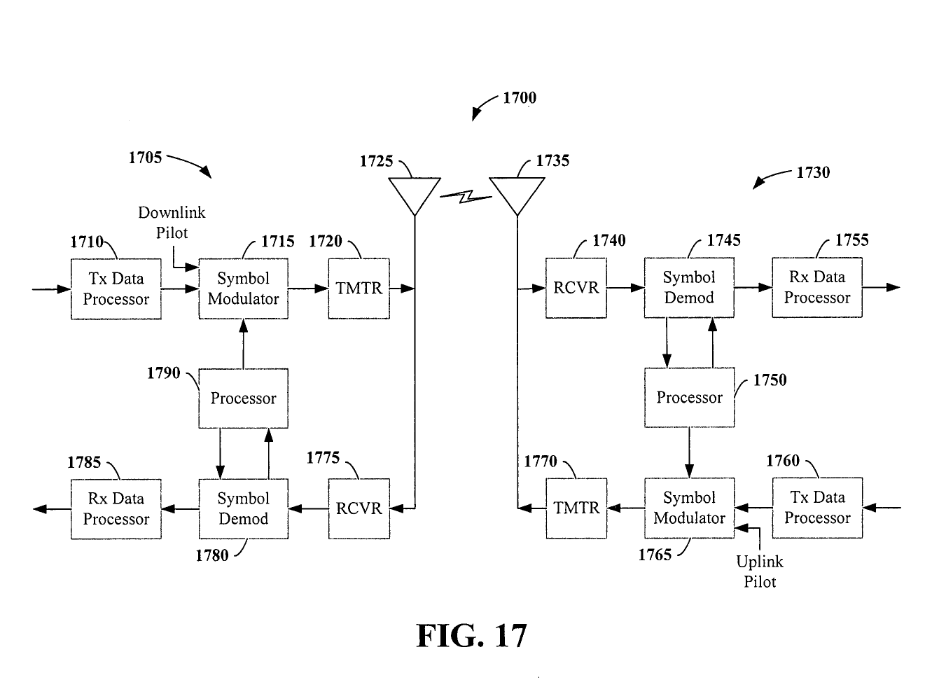

FIG. 17 shows an exemplary wireless communication system 1700. The wireless communication system 1700 depicts one base station and one user device for sake of brevity. However, it is to be appreciated that the system can include more than one base station and/or more than one user device, wherein additional base stations and/or user devices can be substantially similar or different from the exemplary base station and user device described below. In addition, it is to be appreciated that the base station and/or the user device can employ the systems (FIGS. 1, 3-4 and 15-16) and/or methods (FIGS. 610 and 12-14) described herein.

Referring now to FIG. 17, on a downlink, at access point 1705, a transmit (TX) data processor 1710 receives, formats, codes, interleaves, and modulates (or symbol maps) traffic data and provides modulation symbols (“data symbols”). A symbol modulator 1715 receives and processes the data symbols and pilot symbols and provides a stream of symbols. Symbol modulator 1715 multiplexes data and pilot symbols and provides them to a transmitter unit (TMTR) 1720. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 1720 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1725 to the user devices. At user device 1730, an antenna 1735 receives the downlink signal and provides a received signal to a receiver unit (RCVR) 1740. Receiver unit 1740 conditions (e.g., filters, amplifies, and frequency downconverts) the received signal and digitizes the conditioned signal to obtain samples. A symbol demodulator 1745 demodulates and provides received pilot symbols to a processor 1750 for channel estimation. Symbol demodulator 1745 further receives a frequency response estimate for the downlink from processor 1750, performs data demodulation on the received data symbols to obtain data symbol estimates (which are estimates of the transmitted data symbols), and provides the data symbol estimates to an RX data processor 1755, which demodulates (i.e., symbol demaps), deinterleaves, and decodes the data symbol estimates to recover the transmitted traffic data. The processing by symbol demodulator 1745 and RX data processor 1755 is complementary to the processing by symbol modulator 1715 and TX data processor 1710, respectively, at access point 1705.

On the uplink, a TX data processor 1760 processes traffic data and provides data symbols. A symbol modulator 1765 receives and multiplexes the data symbols with pilot symbols, performs modulation, and provides a stream of symbols. A transmitter unit 1770 then receives and processes the stream of symbols to generate an uplink signal, which is transmitted by the antenna 1735 to the access point 1705.

At access point 1705, the uplink signal from user device 1730 is received by the antenna 1725 and processed by a receiver unit 1775 to obtain samples. A symbol demodulator 1780 then processes the samples and provides received pilot symbols and data symbol estimates for the uplink. An RX data processor 1785 processes the data symbol estimates to recover the traffic data transmitted by user device 1730. A processor 1790 performs channel estimation for each active user device transmitting on the uplink. Multiple user devices may transmit pilot concurrently on the uplink on their respective assigned sets of pilot subcarriers, where the pilot subcarrier sets may be interlaced.

Processors 1790 and 1750 direct (e.g., control, coordinate, manage, etc.) operation at access point 1705 and user device 1730, respectively. Respective processors 1790 and 1750 can be associated with memory units (not shown) that store program codes and data. Processors 1790 and 1750 can utilize any of the methodologies described herein. Respective Processors 1790 and 1750 can also perform computations to derive frequency and impulse response estimates for the uplink and downlink, respectively.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for determining a modulation type of a received signal for a set of subcarriers that has a consistent modulation type, comprising:
determining a modulation symbol closest to the received signal for each of a plurality of modulation types for each subcarrier in the set of subcarriers;
generating a metric for each of the plurality of modulation types based upon the difference between the closest modulation symbol and the received signal for each subcarrier in the set of subcarriers; and
selecting the modulation type of the received signal from the plurality of modulation types based upon the metric.

2. The method of claim 1, further comprising:
representing the received signal as a point in a complex plane; and
representing modulation symbols for the plurality of modulation types as points in the complex plane, the closest modulation symbol is determined based upon the distance in the complex plane between the received signal point and the modulation symbol point.

3. The method of claim 2, the complex plane is represented as a constellation diagram and the points are constellation points.

4. The method of claim 2, the difference between the closest modulation symbol and the received signal is measured based at least in part upon the distance between the received signal point and the modulation symbol point in the complex plane.

5. The method of claim 2, determining the closest modulation symbol further comprising:
determining a set of regions within the complex plane for each modulation type; and
determining a region in which the received signal point is located for each of the set of regions for each subcarrier, the closest modulation symbol for a modulation type corresponds to the region in which the received signal point is located.

6. The method of claim 2, generating a metric for each modulation type over the set of subcarriers further comprises:
summing the distance square between the received signal point and the closest modulation symbol point for the modulation type for each subcarrier in the set of subcarriers.

7. The method of claim 2, generating a metric for each modulation type over the set of subcarriers further comprises:
averaging the distance between the received signal point and the closest modulation symbol point for the modulation point for each subcarrier in the set of subcarriers.

8. The method of claim 1, further comprising:
utilizing the closest modulation symbol for the selected modulation type for each subcarrier to generate a metric indicative of transmitter performance.

9. The method of claim 8, the metric indicative of transmitter performance includes at least one of modulation error ratio (MER), noise variance, channel frequency response and group delay.

10. The method of claim 1, the plurality of modulation types includes at least one of quadrature phase-shift keying (QPSK), layered QPSK with an energy ratio of 6.25 (ER6.25), 16 QAM (quadrature amplitude modulation) and QPSK with energy ratio of 4.0 (ER4).

11. The method of claim 1, the set of subcarriers is a half-interlace.

12. An apparatus that determines a modulation type of a received signal for a set of subcarriers that has a consistent modulation type, comprising:
a processor that determines a modulation symbol closest to the received signal for each of a plurality of modulation types for each subcarrier in the set of subcarriers, generates a metric for each of the plurality of modulation types based upon the difference between the closest modulation symbol and the received signal for each subcarrier in the set of subcarriers and selects the modulation type of the received signal from the plurality of modulation types based upon the metric.

13. The apparatus of claim 12, further comprising a memory, coupled to the processor, that stores information related to the plurality of modulation types.

14. The apparatus of claim 12, the processor represents the received signal and modulation symbols for the plurality of modulation types as points in a complex plane, the closest modulation symbol is determined based upon the distance in the complex plane between the received signal point and the modulation symbol point.

15. The apparatus of claim 14, the difference between the closest modulation symbol and the received signal is the distance between the received signal point and the modulation symbol point in the complex plane.

16. The apparatus of claim 14, the processor partitions the complex plane into a set of regions for each modulation type and determines a region in which the received signal point is located for each of the set of regions for each subcarrier, the closest modulation symbol for a modulation type corresponds to the region in which the received signal point is located.

17. The apparatus of claim 14, the processor sums the distance square between the received signal point and the closest modulation symbol point for the modulation type for each subcarrier in the set of subcarriers to generate the metric.

18. The apparatus of claim 14, the processor utilizes the closest modulation symbol for the selected modulation type for each subcarrier to generate a metric indicative of transmitter performance.

19. The apparatus of claim 12, the plurality of modulation types includes at least one of quadrature phase-shift keying (QPSK), layered QPSK with an energy ratio of 6.25 (ER6.25), 16 QAM (quadrature amplitude modulation) and QPSK with energy ratio of 4.0 (ER4).

20. An apparatus for determining a modulation type of a received signal for a set of subcarriers that has a consistent modulation type, comprising:
means for determining a modulation symbol closest to the received signal for each of a plurality of modulation types for each subcarrier in the set of subcarriers;
means for generating a metric for each of the plurality of modulation types based upon the difference between the closest modulation symbol and the received signal for each subcarrier in the set of subcarriers; and
means for selecting the modulation type of the received signal from the plurality of modulation types based upon the metric.

21. The apparatus of claim 20, further comprising:
means for representing the received signal as a constellation point; and
means for representing modulation symbols for the plurality of modulation types as constellation points, the closest modulation symbol is determined based upon the distance between the received signal point and the modulation symbol point.

22. The apparatus of claim 21, the difference between the closest modulation symbol and the received signal is measured based at least in part upon the distance between the received signal point and the modulation symbol point.

23. The apparatus of claim 21, further comprising:
means for dividing a constellation diagram into a set of regions for each modulation type; and
means for determining a region in which the received signal point is located for each of the sets of regions for each subcarrier, the closest modulation symbol for a modulation type corresponds to the region in which the received signal point is located.

24. The apparatus of claim 21, further comprising:
means for summing the distance square between the received signal point and the closest modulation symbol point for the modulation type for each subcarrier in the set of subcarriers.

25. The apparatus of claim 21, further comprising:
means for utilizing the closest modulation symbol for the selected modulation type for each subcarrier to generate a metric indicative of transmitter performance.

26. The apparatus of claim 20, the plurality of modulation types includes at least one of quadrature phase-shift keying (QPSK), layered QPSK with an energy ratio of 6.25 (ER6.25), 16 QAM (quadrature amplitude modulation) and QPSK with energy ratio of 4.0 (ER4).

27. A computer-readable medium having stored thereon computer-executable instructions for:
determining a modulation symbol closest to a received signal for each of a plurality of modulation types for each subcarrier in a set of subcarriers that has a consistent modulation type;
generating a metric for each of the plurality of modulation types based upon the difference between the closest modulation symbol and the received signal for each subcarrier in the set of subcarriers; and
selecting the modulation type of the received signal from the plurality of modulation types based at least in part upon the metric.

28. The computer-readable medium of claim 27, further comprising instructions for:
representing the received signal as a point in a complex plane; and
representing modulation symbols for the plurality of modulation types as points in the complex plane, the closest modulation symbol is determined based upon the distance in the complex plane between the received signal point and the modulation symbol point.

29. The computer-readable medium of claim 28, the difference between the closest modulation symbol and the received signal is measured based at least in part upon the distance between the received signal point and the modulation symbol point in the complex plane.

30. The computer-readable medium of claim 28, further comprising instructions for:
determining a set of regions within the complex plane for each modulation type; and
determining a region in which the received signal point is located for each of the set of regions for each subcarrier, the closest modulation symbol for a modulation type corresponds to the region in which the received signal point is located.

31. The computer-readable medium of claim 28, further comprising instructions for:
summing the distance square between the received signal point and the closest modulation symbol point for the modulation type for each subcarrier in the set of subcarriers to generate the metric.

32. The computer-readable medium of claim 28, further comprising instructions for:
utilizing the closest modulation symbol for the selected modulation type for each subcarrier to generate a metric indicative of transmitter performance.

33. The computer-readable medium of claim 27, the plurality of modulation types includes at least one of quadrature phase-shift keying (QPSK), layered QPSK with an energy ratio of 6.25 (ER6.25), 16 QAM (quadrature amplitude modulation) and QPSK with energy ratio of 4.0 (ER4).

34. A processor that executes instructions for determining a modulation type of a transmitted signal for a set of subcarriers that has a consistent modulation type, the instructions comprising:
determining a modulation symbol closest to the received signal for each of a plurality of modulation types for each subcarrier in the set of subcarriers;
generating a metric for each of the plurality of modulation types based upon the difference between the closest modulation symbol and the received signal for each subcarrier in the set of subcarriers; and
selecting the modulation type of the received signal from the plurality of modulation types based upon the metric.

35. The processor of claim 34, the instructions further comprising:
representing the received signal as a point in a complex plane; and
representing modulation symbols for the plurality of modulation types as points in the complex plane, the closest modulation symbol is determined based upon the distance in the complex plane between the received signal point and the modulation symbol point.

36. The processor of claim 35, the difference between the closest modulation symbol and the received signal is measured based at least in part upon the distance between the received signal point and the modulation symbol point in the complex plane.

37. The processor of claim 35, the instructions further comprising:
determining a set of regions within the complex plane for each modulation type; and
determining a region in which the received signal point is located for each of the set of regions for each subcarrier, the closest modulation symbol for a modulation type corresponds to the region in which the received signal point is located.

38. The processor of claim 35, the instructions further comprising:
summing the distance square between the received signal point and the closest modulation symbol point for the modulation type for each subcarrier in the set of subcarriers.

39. The processor of claim 35, the instructions further comprising:
utilizing the closest modulation symbol for the selected modulation type for each subcarrier to generate a metric indicative of transmitter performance.
